(19) United States
(12) Patent Application Publication
(10) Pub. No.: US 2009/0132772 A1
(43) Pub. Date: May 21, 2009

(54) System and method for performing data reading and writing on physical storage device

(75) Inventors: Qin-Ping Zhuang, Tianjin (CN); Xuan Du, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/984,748

(22) Filed: Nov. 21, 2007

(51) Int. Cl. G06F 12/00

(52) U.S. Cl. 711/155; 711/E12.021

(57) ABSTRACT

A system and a method for performing data reading and writing on a physical storage device. A plurality of controllers under a common storage environment is used to realize data read and write operation performed on the physical storage device by a remote client. Firstly, the client assigns a controller in the plurality of controllers as a controller for executing the read and write operation, and each controller performs transmission of management data and cache data of the data to be written in the physical storage device through interlink. Then, the assigned controller reads data from the physical storage device or writes data into the physical storage device through corresponding logical storage device.

### BACKGROUND OF THE INVENTION

1. Field of Invention

The present invention relates to a system and a method for performing data reading and writing on a physical storage device, and more particularly, the present invention relates to a system and a method capable of directly performing read and write operation on the physical storage device by using a plurality of controllers under a common storage environment.

2. Related Art

Recently, in order to improve availability and parallel processing capability of a system, usually several controllers share a common practical physical storage device. Performing data read and write operation on the physical storage device by a client through the controllers usually has two implementations.

As shown in FIG. 1, for a physical storage device 60, at any moment, only one controller can be used to perform the data read and write operation on the physical storage device 60. For example, at the time when a controller 20 performs read and write operation on the physical storage device 60 through a logical storage device 40, for the physical storage device 60, final data read and write is always performed through the controller 20. In some systems, a client 10 can perform the data read and write operation on the physical storage device 60 of another controller 20 through a controller 30, and it is realized through interlink between the controller 30 and the controller 20. When the read and write is performed on the physical storage device 60 of the controller 20 through the controller 30, all data transmission 110 is performed in the internal network, and final practical read and write operation is finished on the controller 20 of which the logical storage device 40 belongs.

As shown in FIG. 2, architecture similar to a load balancing cluster is adopted, and the controller 20 and the controller 30 respectively have a corresponding logical storage device 40 and a logical storage device 50. When the client 10 intends to perform the data read and write operation on the physical storage device 60, it is necessary to use a balancer 70 at front end of the controller 20 and the controller 30 to determine which controller is used to execute the data transmission 110 and the read and write operation. However, at any assigned moment, the data read and write operation on the physical storage device 60 is performed only through the logical storage device on only one controller.

Although the above two manners of the conventional art are feasible, certain disadvantages still exist. For the first manner, the expense of realizing the function is that when data flow is larger, the internal network may suffer huge pressure, if the maintenance of the system heavily depends on the internal network (for example pulse signal is transmitted between the controller 20 and the controller 30 through the internal network to determine the state of each other), it is possible to result in read and write operation abnormity. For the second manner, distinctly, the front end balancer 70 for exclusively balancing load and dispatching controller operation is required, which brings additional cost on hardware and software.

### SUMMARY OF THE INVENTION

In order to solve the problems and the disadvantages in the conventional art, the present invention is directed to provide a system and method of performing data reading and writing on a physical storage device. A plurality of controllers under a common storage environment is used to realize read and write operation directly performed on the physical storage device by a client from a remote terminal.

The system of performing data reading and writing on the physical storage device provided by the present invention includes a plurality of controllers and a physical storage device. Each controller respectively has a logical storage device, and the transmission of management data and cache data of the data to be written into the physical storage device is performed among the controllers through interlink. Each controller is connected to a client through an external network. The client performs the data read or write operation on the physical storage device through an assigned controller in the controllers from the remote terminal at an assigned moment. The physical storage device is connected to a logical storage device of each controller, and reads data from the physical storage device or writes data into the physical storage device through the logical storage device.

The management data includes read and write operation type information and data block information required to be read and written sent by the assigned controller executing the read and write operation to other controllers, and information whether cache data of the data block to be read exists in other controllers fed back to the assigned controller by other controllers.

When the cache data of the data block to be read by the assigned controller exists in other controllers or the assigned controller, the assigned controller reads the cache data of the data block in other controllers or the assigned controller and the data of the data block existing in the physical storage device, and transfers the data to the client. When the cache data of the data block to be written by the assigned controller exists in other controllers or the assigned controller, the cache data of the data block in other controllers or the assigned controller is cleared, and the assigned controller writes new data of the data block into the physical storage device.

The method of performing data reading and writing on the physical storage device provided by the present invention includes the following steps.

The client assigns a controller from the plurality of controllers as a controller executing a read and write operation at an assigned moment. Before executing the read and write operation, the assigned controller sends management data including read and write operation type information and information of data block to be read and written to other controllers. After other controllers receives the management data, if cache data of the data block to be read exists in other controllers, the information that the cache data of the data block to be read exists in other controllers is fed back to the assigned controller. When the cache data of the data block to be read by the assigned controller exists in other controllers or the assigned controller, the assigned controller reads the cache data of the data block in the other controllers or the assigned controller and the data of the data block existing in the physical storage device, and transfers the data to the client. When the cache data of the data block to be written by the assigned controller exists in other controllers or the assigned controller, the cache data of the data block in other controllers or the assigned controller is cleared, and new data of the data block is written into the physical storage device by the assigned controller.

Data and information transmission is performed among the controllers through interlink, and each controller is connected to the remote client through an external network.

To sum up, the present invention has the following advantages.

In the system and method of performing data read and write on the physical storage device provided by the present invention, a plurality of interlinked controllers share a common physical storage device, such that the plurality of controllers are coordinated and matched to directly perform the data read and write operation on the physical storage device, without using a load balancer at front end of the controller. Only the management data and the cache data of the data to be written into the physical storage device are transmitted among the controllers through the interlink, so the data transmission amount is relatively small, thereby effectively reducing pressure of transmitting data among controllers through internal network in the conventional art, and greatly improving operating efficiency and application scope of performing data read and write on the physical storage device by the remote client through the controller in the conventional art.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a system block diagram of a system of performing data reading and writing on a physical storage device according to the conventional art;

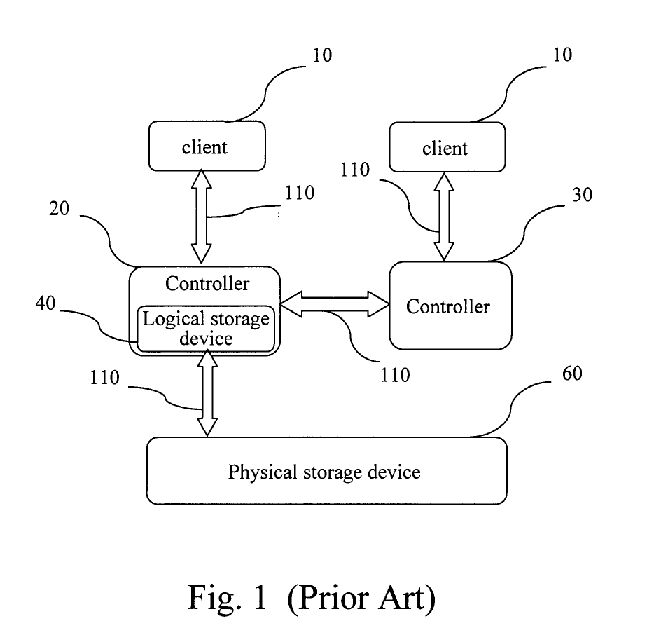

FIG. 2 is a system block diagram of another system of performing data reading and writing on the physical storage device according to the conventional art;

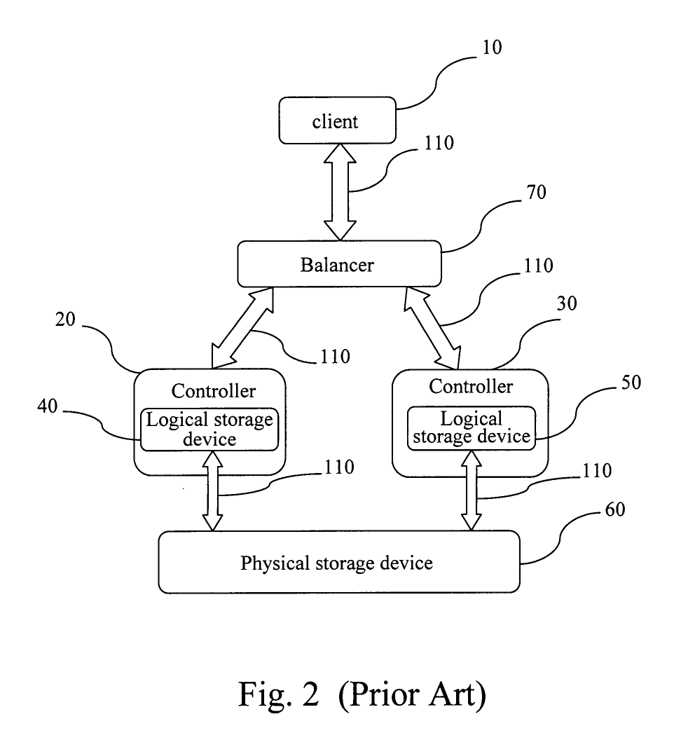

FIG. 3 is a system block diagram of a system of performing data reading and writing on a physical storage device according to the present invention; and

FIG. 4 is a flow chart of a method for performing data reading and writing on the physical storage device according to the present invention.

### DETAILED DESCRIPTION OF THE INVENTION

In the following, the preferred embodiment of the present invention is illustrated in detail with the drawings.

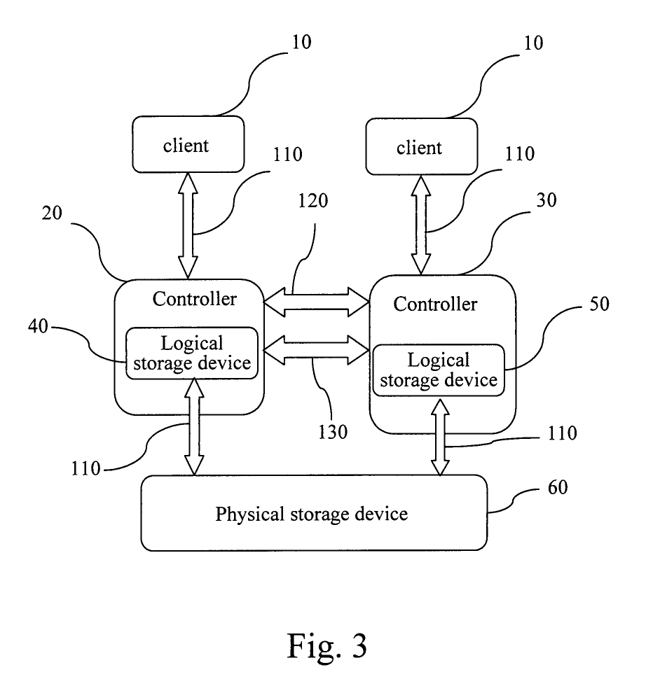

Referring to FIG. 3, a system block diagram of a system of performing data reading and writing on a physical storage device according to the present invention is shown. As shown in the drawing, the system uses a plurality of controllers under a common storage environment to execute data transmission 110 between a client 10 and a physical storage device 60 and to perform read and write operation on the physical storage device 60. Two controllers, namely, a controller 20 and a controller 30 are used as examples to illustrate the implementation in detail.

As shown in FIG. 3, the controller 20 and the controller 30 respectively has a corresponding logical storage device 40 and logical storage device 50, the controller 20 and the controller 30 perform management data transmission 120 and transmission 130 of cache data of the data to be written into the physical storage device 60 through interlink. The interlink is a connection manner including Ethernet or serial attached SCSI (SAS), and the management data includes: read and write operation type information (i.e., the operation is “data read” or “data write”) and information of the data block required to be read and written (i.e., particularly the read and write operation is performed on which data block in the physical storage device 60) sent by the controller 20 executing the read and write operation (it is assumed that the client 10 assigns the controller 20 as the controller performing the data read or the data write on the physical storage device 60 at an assigned moment) to the controller 30, and information about whether the cache data of the data block to be read exists in the controller 30 fed back by the controller 30 to the controller 20. The logical storage device 40 and the logical storage device 50 corresponding to the controller 20 and the controller 30 are connected to the physical storage device 60, and the controller 20 and the controller 30 can read data from the physical storage device 60 or write data into the physical storage device 60 through the logical storage device 40 and the logical storage device 50.

For example, at a certain moment t1, the client 10 intends to reads a certain segment of data S1 on the physical storage device 60 through the logical storage device 40 on the controller 20, so the controller 20 sends the management data to the controller 30 through the internal network. At this time, the cache data of the data S1 to be read does not exist in the controller 30, so the controller 30 doest not feed back the information to the controller 20, after waiting for a period of time, the controller 20 confirms that no controller has the cache data of the data S1 to be red, and then directly reads the data S1 from the physical storage device 60 through the logical storage device 40, and transmits the data S1 to the remote client 10 through the external network (a network connection manner such as Ethernet or fiber channel).

At a certain moment t2 after t1, the client 10 intends to write a segment of data S2 to the physical storage device 60 through the logical storage device 40 on the controller 20, the controller 20 sends the management data to the controller 30 through the internal network. At this time, the cache data of the data S2 to be written does not exist in the controller 30, so the controller 30 does not feed back the information to the controller 20, after waiting for a period of time, the controller 20 starts to write the data S2 to the physical storage device 60 through the logical storage device 40.

At a certain moment t3 after t2, the client 10 intends to read a certain segment of data S2 on the physical storage device 60 through the logical storage device 50 on the controller 30, the controller 30 sends the management data to the controller 20 through the internal network. At this time, if the controller 20 has the cache data of the data S2 having not been written into the physical storage device 60 (i.e., a portion of the data S2), the controller 20 transmits the cache data to the controller 30 through the internal network, and the controller 30 transmits the portion of the data to the client 10. At this time, the controller 30 reads a portion of the data S2 having been written into the physical storage device 60 by the controller 20 from the physical storage device 60 through the logical storage device 50, and transmits the portion of the data S2 to the client 10.

At a certain moment t4 after t2, the client 10 intends to write a new segment of data S2′ into the physical storage device 60 through the logical storage device 50 on the controller 30, and the segment of data S2′ will cover the content of the data S2 on the physical storage device 60, so the controller 30 sends the management data to the controller 20 through the internal network. At this time, if the controller 20 has the cache data of the data S2 having not been written into the physical storage device 60, the cache data of the portion of the data S2 in the controller 20 has become dated old data, and the controller 20 clears this portion of the cache data. After waiting for a period of time, the controller 30 starts to write the new data S2′ into the physical storage device 60 through the logical storage device 50.

At a certain moment t5 after t4, the client 10 intends to read the data S2′ from the physical storage device 60 through the logical storage device 50 on the controller 30. At this time, if the controller 30 has the cache data of the data S2′ having not been written into the physical storage device 60, the controller 30 firstly sends the management data through the internal network to determine that the cache data of the data S2′ does not exist on the other controller, then the controller 30 reads a portion of the data S2′ existing in the physical storage device 60 through the logical storage device 50, and transmits this portion of the data S2′ to the client 10 together with the cache data of the portion of the data S2′ of the controller 30.

At a certain moment t6 after t4, the client 10 intends to write a new segment of data S2″ into the physical storage device 60 through the logical storage device 50 on the controller 30, and the segment of data S2″ will cover the content of the data S2′ on the physical storage device 60. At this time, if the controller 30 has the cache data of the data S2 having not been written into the physical storage device 60, the cache data of the portion of the data S2′ has become dated old data comparing to the new data S2″ to be written, so the controller 30 firstly sends the management data to the controller 20 through the internal network to determine that the related cache data does not exist on the other controller, and the controller 30 clears the cache data of the portion of the data S2′. Then, after waiting for a period of time, the controller 30 writes the new data S2″ into the physical storage device 60 through the logical storage device 50.

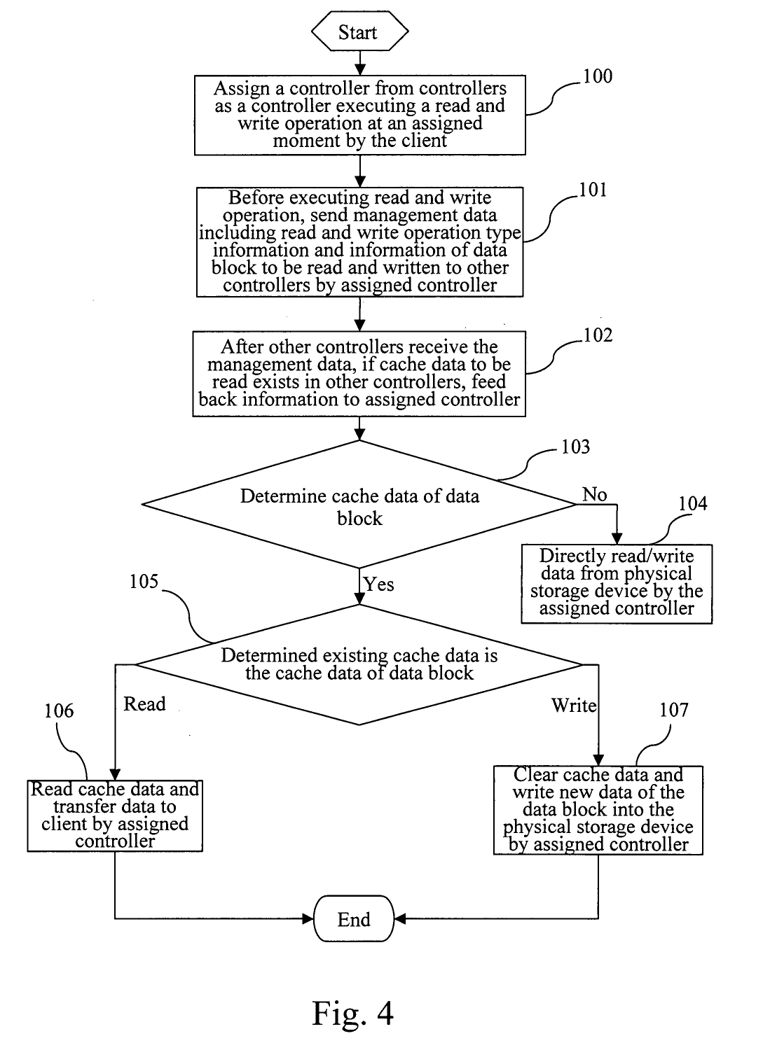

Here, referring to FIG. 4, a flow chart of a method of performing data reading and writing on a physical storage device according to the present invention is shown. As shown in the drawing, the method of performing data reading and writing on a physical storage device of the present invention includes the following steps.

Firstly, the client assigns a controller from a plurality of controllers as a controller executing a read and write operation at an assigned moment (step 100). Before executing the read and write operation, the assigned controller sends management data including read and write operation type information and information of data block to be read and written to other controllers (step 101). After other controllers receive the management data, if the cache data of the data block to be read exists in other controllers, the information that the cache data of the data block to be read exists in other controllers is fed back to the assigned controller (step 102), in which the fed-back information can be considered as a management data. It is determined whether or not the cache data of the data block to be read and written exists in the other controllers and the assigned controller (step 103). If no, the assigned controller directly reads the data from the physical storage device or writes the data to the physical storage device (step 104). If yes, it is determined whether the existing cache data is the cache data of the data block to be read or written by the assigned controller (step 105). When the cache data of the data block to be read by the assigned controller exists in other controllers or the assigned controller, the assigned controller reads the cache data of the data block in the other controllers or the assigned controller and the data of the data block existing in the physical storage device, and transfers the data to the client (step 106). When the cache data of the data block to be written by the assigned controller exists in other controllers or the assigned controller, the cache data of the data block in other controllers or the assigned controller is cleared, and new data of the data block is written into the physical storage device by the assigned controller (step 107).

Particularly, it should be noted that in the method of performing data reading and writing on a physical storage device of the present invention, the data and information transmission is performed among the controllers through interlink. Called interlink is a connection manner including Ethernet or Serial Attached SCSI (SAS). The client and each controller are connected by means of external network, such as Ethernet or fiber channel. In addition, each controller reads data from the physical storage device or writes data into the physical storage device through the logical storage device in each controller.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system of performing data reading and writing on a physical storage device, wherein a plurality of controllers under a common storage environment is used to realize data read and write operation performed on the physical storage device by a remote client, and the system comprises: a plurality of controllers and a physical storage device, wherein:
each controller respectively has a logical storage device, each controller performs transmission of management data and cache data of data to be written into the physical storage device through interlink, each controller is linked to a client through an external network, such that the client performs data read or write operation on the physical storage device at an assigned moment through an assigned controller in the controllers; and
the physical storage device is connected to the logical storage device of each controller, and reads data from the physical storage device or writes data into the physical storage device through the logical storage device.

2. The system of performing data reading and writing on a physical storage device as claimed in claim 1, wherein the management data comprises: read and write operation type information and information of the data block required to be read and written sent by the assigned controller executing the read and write operation to other controllers, and information about whether cache data of the data block to be read exists in other controllers fed back to the assigned controller by other controllers.

3. The system of performing data reading and writing on a physical storage device as claimed in claim 2, wherein when the cache data of the data block to be read by the assigned controller exists in other controllers or the assigned controller, the assigned controller reads the cache data of the data block in other controllers or the assigned controller and the data of the data block existing in the physical storage device, and transfers the data to the client.

4. The system of performing data reading and writing on a physical storage device as claimed in claim 2, wherein when the cache data of the data block to be written by the assigned controller exists in other controllers or the assigned controller, the cache data of the data block in other controllers or the assigned controller is cleared, and the assigned controller writes new data of the data block into the physical storage device.

5. The system of performing data reading and writing on a physical storage device as claimed in claim 1, wherein the interlink is a connection manner comprising Ethernet or serial attached SCSI (SAS).

6. The system of performing data reading and writing on a physical storage device as claimed in claim 1, wherein each controller and the client are connected by means of external network comprising Ethernet or fiber channel.

7. A method of performing data reading and writing on a physical storage device, wherein a plurality of controllers under a common storage environment is used to realize data read and write operation performed on the physical storage device by a remote client, the method comprising:
assigning a controller from the plurality of controllers as a controller executing a read and write operation at an assigned moment by the client;
before executing the read and write operation, sending management data comprising read and write operation type information and information of data block to be read and written to other controllers by the assigned controller;
after other controllers receive the management data, if the cache data of the data block to be read exists in other controllers, feeding back the information that the cache data of the data block to be read exists in other controllers to the assigned controller;
when the cache data of the data block to be read by the assigned controller exists in other controllers or the assigned controller, reading the cache data of the data block in the other controllers or the assigned controller and the data of the data block existing in the physical storage device, and transferring the data to the client by the assigned controller;
when the cache data of the data block to be written by the assigned controller exists in other controllers or the assigned controller, clearing the cache data of the data block in other controllers or the assigned controller, and writing new data of the data block into the physical storage device by the assigned controller.

8. The method of performing data reading and writing on a physical storage device as claimed in claim 7, wherein data and information transmission is performed among the controllers through interlink.

9. The method of performing data reading and writing on a physical storage device as claimed in claim 7, the interlink is a connection manner comprising Ethernet or SAS.

10. The method of performing data reading and writing on a physical storage device as claimed in claim 7, wherein each controller and the client are connected by means of external network comprising Ethernet or fiber channel.
